(19) United States
(12) Patent Application Publication
(10) Pub. No.: US 2018/0281403 A1
(43) Pub. Date: Oct. 4, 2018

(54) LIQUID EJECTING HEAD, LINE HEAD, AND LIQUID EJECTING APPARATUS

(71) Applicant: SEIKO EPSON CORPORATION, Tokyo (JP)

(72) Inventors: Isamu TOGASHl, Matsumoto (JP); Yoichi YAMADA, Shiojiri (JP)

(21) Appl. No.: 15/524,996

(22) PCT Filed: Oct. 30, 2015
(86) PCT No.: PCT/JP2015/005478

§ 371 Date: May 5, 2017

(30) Foreign Application Priority Data
Nov. 12, 2014 (JP) 2014-229440
Nov. 12, 2014 (JP) 2014-229441

(51) Int. Cl. B41J 2/145

(52) U.S. Cl. CPC B41J 2/145

(57) ABSTRACT

To effectively prevent contact between an ejecting surface on which a plurality of nozzles are installed and a medium.

A liquid ejecting head includes a liquid ejecting portion 32 that ejects ink from a plurality of nozzles N, a fixation plate 38 that includes a first surface Q1 to which the liquid ejecting portion 32 is fixed and a second surface Q2 which is opposite to the first surface Q1 and that is provided with an opening 52 formed thereon which exposes the plurality of nozzles N, and a protrusion 60 that is installed on the fixation plate 38 and protrudes toward the medium side from the second surface Q2.

### TECHNICAL FIELD

The present invention relates to a technique of ejecting liquid such as ink.

### BACKGROUND ART

A technique of ejecting liquid, in which liquid is ejected onto a medium such as a printing paper sheet from a plurality of nozzles, has a problem that liquid remaining on an ejecting surface, on which the plurality of nozzles are formed, may adhere to the medium. In order to solve such a problem, for example, PTL 1 discloses a liquid discharging apparatus in which movable pieces are installed on the upstream side and the downstream side in a medium transportation direction of a discharging head in which a plurality of nozzles are formed. The movable pieces protrude toward the medium side with respect to an ejecting surface. In the above-described configuration, the medium which approaches the ejecting surface due to rising or the like comes into contact with the movable pieces. Therefore, it is possible to prevent contact between the ejecting surface and the medium (furthermore, it is also possible to prevent adhering of liquid remaining on the ejecting surface).

### CITATION LIST

### Patent Literature

PTL 1: Japanese Unexamined Patent Application Publication No. 2009-160786

### SUMMARY OF INVENTION

### Technical Problem

However, the technique of PTL 1 has a problem that it is not possible to effectively control the contact between the ejecting surface and the medium at a position between the movable piece on the upstream side and the movable piece on the downstream side since the movable pieces are installed on the upstream side and the downstream side of the discharging head. If the movable pieces are formed to be sufficiently high with respect to the ejecting surface, it is possible to suppress the contact between the ejecting surface and the medium. However, it is necessary to expand a gap (a so-called platen gap) between the medium and the ejecting surface in order to secure the heights of the movable pieces. In addition, there is a problem that the larger the gap between the medium and the ejecting surface, the more obvious an error in landing position of liquid from a nozzle with respect to a surface of the medium. In consideration of the above circumstances, an object of the invention is to effectively prevent contact between a medium and an ejecting surface on which a plurality of nozzles are installed.

### Solution to Problem

### [Aspect 1]

In order to solve the above-described problem, a liquid ejecting head according to a preferred aspect (Aspect 1) of the invention includes a liquid ejecting portion that ejects liquid from a plurality of nozzles, a fixation plate that includes a first surface to which the liquid ejecting portion is fixed and a second surface which is opposite to the first surface and that is provided with an opening formed thereon which exposes the plurality of nozzles, and a protrusion that is installed on the fixation plate and protrudes from the second surface. In Aspect 1, since the protrusion which protrudes from the second surface is installed on the fixation plate, it is possible to reduce a possibility of contact between the plurality of nozzles of the liquid ejecting portion or the second surface of the fixation plate and the medium (in addition, a possibility of adhering of liquid in the opening or the like to the medium). In addition, since the protrusion is installed on the fixation plate to which the liquid ejecting portion is fixed, a distance between the opening of the fixation plate and the protrusion is short in comparison with a configuration in which the protrusion is formed on an element other than the fixation plate. Accordingly, the above-described effect that it is possible to reduce a possibility of adhering of liquid in the opening or the like to the medium becomes particularly significant. Meanwhile, the short distance between the opening of the fixation plate and the protrusion means that the height of the protrusion required to prevent the adhering of liquid in the opening is reduced. Accordingly, there is an advantage that a gap that needs to be provided between the medium and the fixation plate is shortened and thus an error in landing position of liquid with respect to a surface of the medium is reduced.

### [Aspect 2]

In the liquid ejecting head according to a preferred example (Aspect 2) of Aspect 1, a plurality of the liquid ejecting portions which are fixed to the first surface are provided, and the fixation plate is provided with a plurality of the openings formed thereon which correspond to the plurality of liquid ejecting portions. In Aspect 2, since the plurality of liquid ejecting portions are fixed to the first surface of the fixation plate, it is possible to expand an area to which liquid is ejected in comparison with a configuration in which only one liquid ejecting portion is installed.

### [Aspect 3]

In a preferred example (Aspect 3) of Aspect 2, the protrusion is installed between the plurality of openings. In Aspect 3, since the protrusion is installed between the plurality of openings, it is possible to shorten a distance between the protrusion and each opening in comparison with a configuration in which the protrusion is formed to surround the plurality of openings, for example (in addition, it is possible to effectively reduce a possibility of adhering of liquid in the opening or the like to the medium). In addition, there is an advantage that it is possible to reduce a possibility of adhering of liquid which adheres to each of the plurality of openings or the like to the medium by using one protrusion.

### [Aspect 4]

In a preferred example (Aspect 4) of Aspect 2 or 3, the protrusion is installed being elongated in a second direction which intersects a first direction in which the plurality of openings are arranged. In Aspect 4, since the protrusion is installed being elongated in the second direction which intersects the first direction in which the plurality of openings are arranged, there is an advantage that it is possible to prevent contact between the second surface and the medium over a wide range in the second direction.

### [Aspect 5]

In a preferred example (Aspect 5) of Aspect 4, a gap between a central portion of the protrusion and the opening in a direction orthogonal to the second direction is smaller than a gap between an end portion of the protrusion and the opening in the direction orthogonal to the second direction. In Aspect 5, since the gap between the central portion of the protrusion and the opening is smaller than the gap between the end portion of the protrusion and the opening, it is possible to prevent the contact between the second surface of the fixation plate and the medium even in a configuration in which the closer to the central portion of the protrusion, the more the medium is deformed.

### [Aspect 6]

In a preferred example (Aspect 6) of any one of Aspects 1 to 5, the height of a central portion of the protrusion is larger than the height of an end portion of the protrusion. In Aspect 6, since the height of the central portion of the protrusion is larger than the height of the end portion of the protrusion, there is an advantage that it is possible to effectively prevent the contact between the second surface of the fixation plate and the medium as with Aspect 5.

### [Aspect 7]

In a preferred example (Aspect 7) of any one of Aspects 1 to 5, the height of the protrusion is constant over an area of 90% or more of the entire length of the protrusion. In Aspect 7, since the height of the protrusion is constant over an area of 90% or more of the entire length of the protrusion, it is possible to shorten a gap between the second surface and the medium in comparison with Aspect 6. Note that, the height of the protrusion being “constant” means that the height is substantially constant within a range of manufacturing error.

### [Aspect 8]

In the liquid ejecting head according to a preferred example (Aspect 8) of any one of Aspects 4 to 7, a plurality of the protrusions including a first protrusion and a second protrusion are provided, and the first protrusion and the second protrusion partially overlap each other in the second direction. In Aspect 8, since the first protrusion and the second protrusion are installed such that the first protrusion and the second protrusion partially overlap each other in the second direction (the entire length of the protrusion is suppressed), there is an advantage that it is possible to suppress deformation of the fixation plate which is attributable to installation of the protrusion. Meanwhile, since the first protrusion and the second protrusion partially overlap each other, the contact between the second surface of the fixation plate and the medium is effectively prevented.

### [Aspect 9]

In a preferred example (Aspect 9) of any one of Aspects 1 to 8, the protrusion is integrally formed with the fixation plate through drawing with respect to the fixation plate. In Aspect 9, since the protrusion is integrally formed with the fixation plate through the drawing with respect to the fixation plate, a decrease in number of components of the liquid ejecting head and simplification of a manufacturing step are realized.

### [Aspect 10]

In a preferred example (Aspect 10) of any one of Aspects 1 to 8, the protrusion is formed separately from the fixation plate and is fixed to the fixation plate. In Aspect 10, since the protrusion which is formed separately from the fixation plate is fixed to the fixation plate, there is an advantage that it is possible to suppress deformation of the fixation plate (a decrease in flatness which is attributable to the drawing) in comparison with Aspect 9, for example.

### [Aspect 11]

In a preferred example (Aspect 11) of Aspect 10, the protrusion is installed on a bonded portion, which is bonded to the first surface of the fixation plate, and protrudes toward the second surface side through a through hole of the fixation plate. In Aspect 11, since the bonded portion on which the protrusion is installed is bonded to the first surface of the fixation plate, there is an advantage that it is possible to reduce a possibility of adhering of an adhesive for bonding the protrusion to the fixation plate to the second surface in comparison with a configuration (for example, Aspect 12 which will be described below) in which the protrusion is bonded to the second surface of the fixation plate, for example.

### [Aspect 12]

In a preferred example (Aspect 12) of Aspect 10, the protrusion is bonded to the second surface of the fixation plate. In Aspect 12, since the protrusion is bonded to the second surface of the fixation plate, there is an advantage that it is easy to secure mechanical strength of the protrusion (for example, it is possible to prevent falling-off or the like of the protrusion which is attributable to collision with the medium) in comparison with above-described Aspect 11, for example.

### [Aspect 13]

In a preferred example (Aspect 13) of any one of Aspects 1 to 12, the fixation plate includes a peripheral edge portion which is bent with respect to the first surface, and the protrusion is not formed in a region between the peripheral edge portion and the opening. In Aspect 13, since the protrusion is not formed in the region between the peripheral edge portion and the opening of the fixation plate, there is an advantage that it is possible to reduce a possibility of an error in position of the opening and the protrusion and an error in positional relationship between the opening and the protrusion which are attributable to bending of the peripheral edge portion.

### [Aspect 14]

In a preferred example (Aspect 14) of any one of Aspects 1 to 13, a member of the liquid ejecting portion which is boded to the fixation plate does not overlap the protrusion in plan view. Accordingly, in a configuration (Aspect 9) in which the protrusion is integrally formed with the fixation plate through the drawing with respect to the fixation plate, it is possible to firmly fix the liquid ejecting portion to the fixation plate by securing a sufficient area of a region in which the liquid ejecting portion and the first surface of the fixation plate are brought into close contact. In addition, in a configuration (Aspect 11) in which the bonded portion on which the protrusion is installed is bonded to the first surface of the fixation plate, there is an advantage that it is possible to easily prevent interference between the bonded portion and the liquid ejecting portion.

### [Aspect 15]

In a preferred example (Aspect 15) of any one of Aspects 1 to 14, a hydrophilic filler is formed in the opening of the fixation plate and a surface of the protrusion is subjected to water-repellent treatment. In Aspect 15, since the filler is formed in the opening of the fixation plate, there is an advantage that it is possible to suppress intrusion and accumulation of liquid with respect to a space in the opening. Meanwhile, since the filler is hydrophilic and the surface of the protrusion is subjected to the water-repellent treatment, it is possible to effectively prevent adhering of liquid to the surface of the protrusion.

### [Aspect 16]

In a preferred example (Aspect 16) of any one of Aspects 1 to 15, an angle between an end surface in a longitudinal direction of the protrusion and the second surface is smaller than an angle between a side surface of the protrusion and the second surface. In Aspect 16, since the angle of the end surface in the longitudinal direction of the protrusion is smaller than the angle of the side surface, it is possible to reduce a possibility of a leading end of the medium being engaged with a corner portion at which the second surface and the end surface intersect each other (in addition, a possibility of deformation of the medium) in comparison with a configuration in which the end surface of the protrusion is steep with respect to the second surface, for example.

### [Aspect 17]

In a preferred example (Aspect 17) of any one of Aspects 1 to 16, the second surface of the fixation plate includes an annular sealed region which abuts onto a sealing body which air-tightly closes the plurality of nozzles and the protrusion is formed in a region on the second surface other than the sealed region. In Aspect 17, since the protrusion is formed in a region on the second surface other than the annular sealed region which abuts onto the sealing body, there is an advantage that it is possible to sufficiently air-tightly close each nozzle by bring the sealing body into close contact with the second surface of the fixation plate in comparison with a configuration in which the protrusion is formed in a sealed region L.

### [Aspect 18]

In a preferred example (Aspect 18) of Aspect 17, the protrusion is formed on the inside of an inner peripheral edge of the sealed region. In Aspect 18, since the protrusion is formed on the inside of the inner peripheral edge of the sealed region (that is, in a region surrounded by the annular sealed region), there is an advantage that a distance between the opening of the fixation plate and the protrusion is shortened.

### [Aspect 19]

In a preferred example (Aspect 19) of any one of Aspects 1 to 16, the second surface of the fixation plate includes an annular sealed region which abuts onto a sealing body which air-tightly closes the plurality of nozzles, and at least a portion of the protrusion overlaps the sealed region on the second surface. In Aspect 19, since the protrusion is formed over a wide range on the second surface so that at least a portion of the protrusion overlaps the sealed region, the above-described effect that it is possible to reduce a possibility of the contact between the second surface of the fixation plate and the medium becomes particularly significant.

### [Aspect 20]

In order to solve the above-described problem, a line head according to a preferred aspect (Aspect 1) of the invention, which is a line head elongated in a first direction, includes an ejecting surface on which a plurality of nozzles ejecting liquid are installed and a protrusion that is installed along a second direction intersecting the first direction and protrudes from the ejecting surface. In Aspect 1, the protrusion that protrudes from the ejecting surface on which the plurality of nozzles are installed is installed along the second direction intersecting (is orthogonal to or is inclined with respect to) an X direction which is a longitudinal direction of the line head. Therefore, there is an advantage that it is possible to prevent the contact between the ejecting surface and the medium over a wide range in a direction intersecting the first direction in comparison with a configuration in which the protrusion is formed along the first direction.

### [Aspect 21]

In a preferred example (Aspect 21) of Aspect 20, the plurality of nozzles are installed such that a pitch in the first direction is narrower than a pitch in a direction perpendicular to the first direction. In Aspect 21, since the pitch between the plurality of nozzles in the first direction is narrower than the pitch in the direction perpendicular to the first direction, it is possible to enhance the resolution (dot density) of the medium in the first direction.

### [Aspect 22]

In a preferred example (Aspect 22) of Aspect 20 or 21, the second direction is a direction which is inclined with respect to the first direction. In Aspect 22, since a distribution range of the protrusion in the first direction is wider than that in a configuration in which the protrusion is formed along a direction orthogonal to the first direction, the above-described effect that it is possible to prevent the contact between the ejecting surface and the medium becomes particularly significant.

### [Aspect 23]

In a preferred example (Aspect 23) of any one of Aspects 20 to 22, a plurality of the protrusions are installed in a region in which the plurality of nozzles are distributed. In Aspect 23, since the plurality of protrusions are installed in the region in which the plurality of nozzles are distributed, the above-described effect that it is possible to prevent the contact between the ejecting surface and the medium becomes particularly significant in comparison with a configuration in which the protrusion is formed only on the outside of the region in which the plurality of nozzles are distributed or a configuration in which only one protrusion is formed in the region, for example.

### [Aspect 24]

In a preferred example (Aspect 24) of Aspect 23, the plurality of protrusions are installed on a single member. In Aspect 24, since the plurality of protrusions are installed on the single member, it is possible to install the plurality of protrusions at a high density in comparison with a configuration in which the plurality of protrusions are installed on a plurality of members while being scattered. Therefore, the above-described effect that it is possible to prevent the contact between the ejecting surface and the medium becomes particularly significant.

### [Aspect 25]

In a preferred example (Aspect 25) of Aspect 23 or 24, the plurality of protrusions are formed to be line-symmetric with respect to an axis which is orthogonal to the first direction. In Aspect 25, since the plurality of protrusions are formed to be line-symmetric with respect to the axis which is orthogonal to the first direction, there is an advantage that it is possible to prevent the contact between the ejecting surface and the medium over a wide range in the first direction.

### [Aspect 26]

In a preferred example (Aspect 26) of any one of Aspects 20 to 25, the height of the protrusion with respect to the ejecting surface is larger than the plate thickness of a substrate including the ejecting surface. In Aspect 26, since the height of the protrusion is secured such that the height of the protrusion is larger than the plate thickness of the substrate including the ejecting surface, there is an advantage that it is possible to prevent the contact between the ejecting surface and the medium in comparison with a configuration in which the height of the protrusion is smaller than the plate thickness of the substrate.

### [Aspect 27]

The line head according to a preferred example (Aspect 27) of any one of Aspects 20 to 26 further includes a reserving chamber that reserves liquid to be ejected from the plurality of nozzles. The protrusion is installed on a position which overlaps the reserving chamber in plan view. In Aspect 27, since the region which overlaps the reserving chamber in plan view is used for formation of the protrusion, it is possible to arrange the plurality of nozzles N at a high density in comparison with a configuration in which the protrusion and the reserving chamber do not overlap each other in plan view.

### [Aspect 28]

The line head according to a preferred example (Aspect 28) of any one of Aspects 20 to 27 further includes a reserving chamber that reserves liquid to be ejected from the plurality of nozzles and a damper chamber for vibrating an elastic film that evens out a fluctuation in pressure in the reserving chamber. The protrusion is installed on a position which does not overlap the damper chamber in plan view. In Aspect 28, since the protrusion is formed such that the protrusion does not overlap the damper chamber in plan view, there is an advantage that an error in characteristic (for example, strength characteristic) of the damper chamber attributable to the protrusion is reduced in comparison with a configuration in which the protrusion and the damper chamber overlap each other in plan view, for example.

### [Aspect 29]

In a preferred example (Aspect 29) of any one of Aspects 20 to 28, the protrusion is integrally formed with a substrate including the ejecting surface through drawing with respect to the substrate. In Aspect 29, since the protrusion is integrally formed with the substrate including the ejecting surface through the drawing with respect to the substrate, a decrease in number of components of the line head and simplification of a manufacturing step are realized.

### [Aspect 30]

In a preferred example (Aspect 30) of any one of Aspects 20 to 28, the protrusion is formed separately from a substrate including the ejecting surface and is fixed to the substrate. In Aspect 30, since the protrusion which is formed separately from the substrate including the ejecting surface is fixed to the substrate, there is an advantage that it is possible to suppress deformation of the substrate (a decrease in flatness which is attributable to the drawing) in comparison with Aspect 29, for example.

### [Aspect 31]

In a preferred example (Aspect 31) of any one of Aspects 20 to 30, an angle between an end surface in a longitudinal direction of the protrusion and the ejecting surface is smaller than an angle between a side surface of the protrusion and the ejecting surface. In Aspect 31, since the angle of the end surface in the longitudinal direction of the protrusion is smaller than the angle of the side surface, it is possible to reduce a possibility of a leading end of the medium being engaged with a corner portion at which the ejecting surface and the end surface intersect each other (in addition, a possibility of deformation of the medium) in comparison with a configuration in which the end surface of the protrusion is steep with respect to the ejecting surface, for example.

### [Aspect 32]

A liquid ejecting apparatus according to a preferred aspect (Aspect 32) of the invention includes the line head according to any one of Aspects 1 to 31 and a transportation mechanism that transports a medium in a direction which is orthogonal to the first direction. A preferred example of the liquid ejecting apparatus is a printing apparatus that ejects ink onto a medium such as a printing paper sheet. However, the purpose of use of the liquid ejecting apparatus according to the invention is not limited to printing.

### BRIEF DESCRIPTION OF DRAWINGS

FIG. 1 is a view illustrating a configuration of a printing apparatus according to a first embodiment of the invention.

FIG. 2 is a view illustrating the configuration of the printing apparatus while focusing on transportation of a medium.

FIG. 3 is a plan view illustrating a surface of a liquid ejecting unit which faces the medium.

FIG. 4 is an exploded perspective view illustrating a liquid ejecting head.

FIG. 5 is a sectional view illustrating a portion of a liquid ejecting portion which corresponds to one nozzle.

FIG. 6 is a view (six view orthographic projection) illustrating a configuration of a fixation plate.

FIG. 7 is a view for explaining a relationship between the fixation plate and the liquid ejecting portion (a sectional view taken along line VII-VII of FIG. 6).

FIG. 8 is an enlarged view illustrating a protrusion.

FIG. 9 is a view for explaining a relationship between a sealing mechanism (a cap) and the liquid ejecting head.

FIG. 10 is a view for explaining a relationship between a fixation plate and a liquid ejecting portion according to a second embodiment.

FIG. 11 is a perspective view illustrating a protrusion according to the second embodiment.

FIG. 12 is a view for explaining a relationship between a fixation plate and a liquid ejecting portion according to a modification example of the second embodiment.

FIG. 13 is a plan view illustrating a second surface of a fixation plate according to a third embodiment.

FIG. 14 is a plan view illustrating a second surface of a fixation plate according to a modification example of the third embodiment.

FIG. 15 is a plan view illustrating the second surface of the fixation plate according to the modification example of the third embodiment.

FIG. 16 is a plan view illustrating a second surface of a fixation plate according to a fourth embodiment.

FIG. 17 is a plan view illustrating an ejecting surface of a liquid ejecting unit according to a fifth embodiment.

FIG. 18 is a plan view illustrating an ejecting surface according to a modification example of the fifth embodiment.

FIG. 19 is a plan view illustrating an ejecting surface of a liquid ejecting unit according to a sixth embodiment.

FIG. 20 is a view for explaining the planar shapes of protrusions according to modification examples.

FIG. 21 is a view for explaining the sectional shapes of protrusions according to modification examples.

FIG. 22 is a plan view illustrating a second surface of a fixation plate according to a modification example.

### DESCRIPTION OF EMBODIMENTS

### First Embodiment

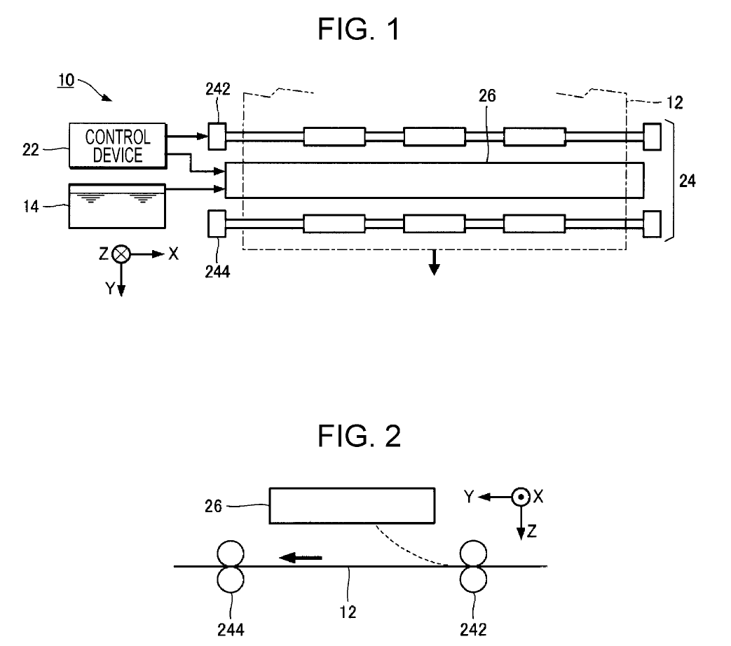

FIG. 1 is a view partially illustrating a configuration of an ink jet type printing apparatus 10 according to a first embodiment of the invention. The printing apparatus 10 according to the first embodiment is a liquid ejecting apparatus that ejects ink, which is an example of liquid, to a medium (ejection target) 12 such as a printing paper sheet and the printing apparatus 10 includes a control device 22, a transportation mechanism 24, and a liquid ejecting unit 26. A liquid container (a cartridge) 14 which reserves ink is mounted onto the printing apparatus 10.

The control device 22 collectively controls each element of the printing apparatus 10. The transportation mechanism 24 transports the medium 12 in a Y direction under control of the control device 22. FIG. 2 is a view illustrating a configuration of the printing apparatus 10 while focusing on transportation of the medium 12. As illustrated in FIGS. 1 and 2, the transportation mechanism 24 includes a first roller 242 and a second roller 244. The first roller 242 is positioned on the negative side in the Y direction of the second roller 244 (the upstream side in a transportation direction of the medium 12) and transports the medium 12 to the second roller 244 side and the second roller 244 transports the medium 12, which is transported from the first roller 242, to the positive side in the Y direction. The configuration of the transportation mechanism 24 is not limited to the above-described example.

As illustrated by using a broken line in FIG. 2, the medium 12 may be deformed (for example, may curl) toward the liquid ejecting unit 26 side at a position between the first roller 242 and the second roller 244. For example, in a case where ink is ejected onto both surfaces of the medium 12 with the medium 12 being sequentially inverted (duplex printing), the deformation of the medium 12 becomes particularly significant with ink being ejected onto only one surface of the medium 12. If ink is sufficiently dried in a state where printing has been performed on one surface, the deformation of the medium 12 can be suppressed. However, it is difficult in fact to secure a sufficient time for a drying process in a case of high-speed printing in which printing on a plurality of mediums 12 is performed in a short time, for example. Therefore, it is necessary to transport the medium 12 in a state of being deformed toward the liquid ejecting unit 26 side by using the transportation mechanism 24.

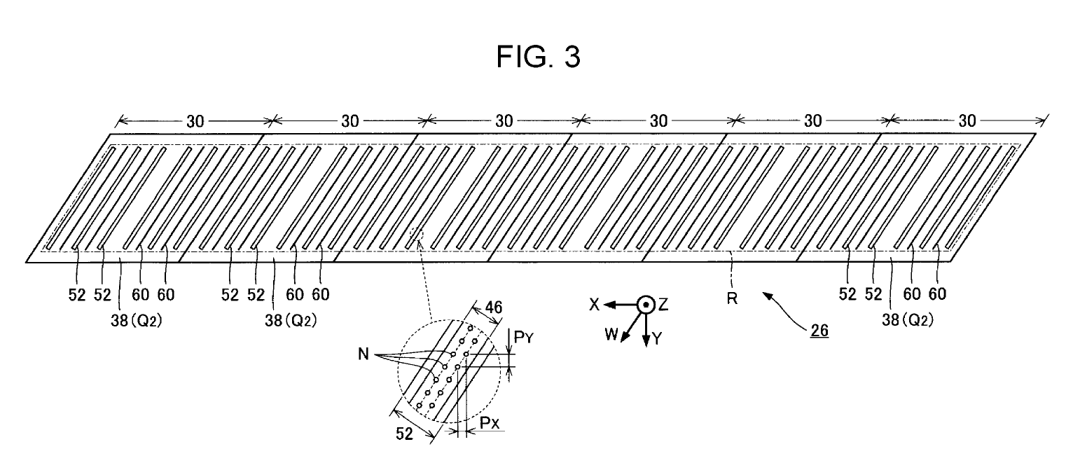

The liquid ejecting unit 26 in FIG. 1 ejects ink supplied from the liquid container 14 onto the medium 12 under control of the control device 22. The liquid ejecting unit 26 according to the first embodiment is a line head elongated in an X direction (a first direction) which is orthogonal to the Y direction. FIG. 3 is a plan view illustrating a surface of the liquid ejecting unit 26 which faces the medium 12 (hereinafter, referred to as an “ejecting surface”). As illustrated in FIG. 3, a plurality of nozzles (ejection holes) N are installed on the ejecting surface of the liquid ejecting unit 26. The liquid ejecting unit 26 is disposed such that the ejecting surface faces the medium 12 with a predetermined gap therebetween while being parallel to an X-Y plane. In parallel to transportation of the medium 12 which is performed by the transportation mechanism 24, the liquid ejecting unit 26 ejects ink onto the medium 12 so that a desired image is formed on a surface of the medium 12. Note that, a direction perpendicular to the X-Y plane (for example, a plane parallel to a surface of the medium 12 with no deformation) will be referred to as a Z direction below. A direction in which the liquid ejecting unit 26 ejects ink (for example, a downward direction in a vertical direction) corresponds to the Z direction. In addition, a lateral direction of a region R on the ejecting surface of the liquid ejecting unit 26 in which the plurality of nozzles N are distributed corresponds to the Y direction and a longitudinal direction of the region R corresponds to the X direction. In a case where the medium 12 which has been deformed as illustrated by using the broken line in FIG. 2 is transported, the medium 12 may come into contact with the ejecting surface of the liquid ejecting unit 26.

As illustrated in FIG. 3, the liquid ejecting unit 26 according to the first embodiment includes a plurality of (six in the first embodiment) liquid ejecting heads 30. Each liquid ejecting head 30 ejects ink supplied from the liquid container 14 via the plurality of nozzles N. As illustrated in FIG. 3, the plurality of liquid ejecting heads 30 are fixed to a housing (not shown) of the liquid ejecting unit 26 while being arranged in the X direction.

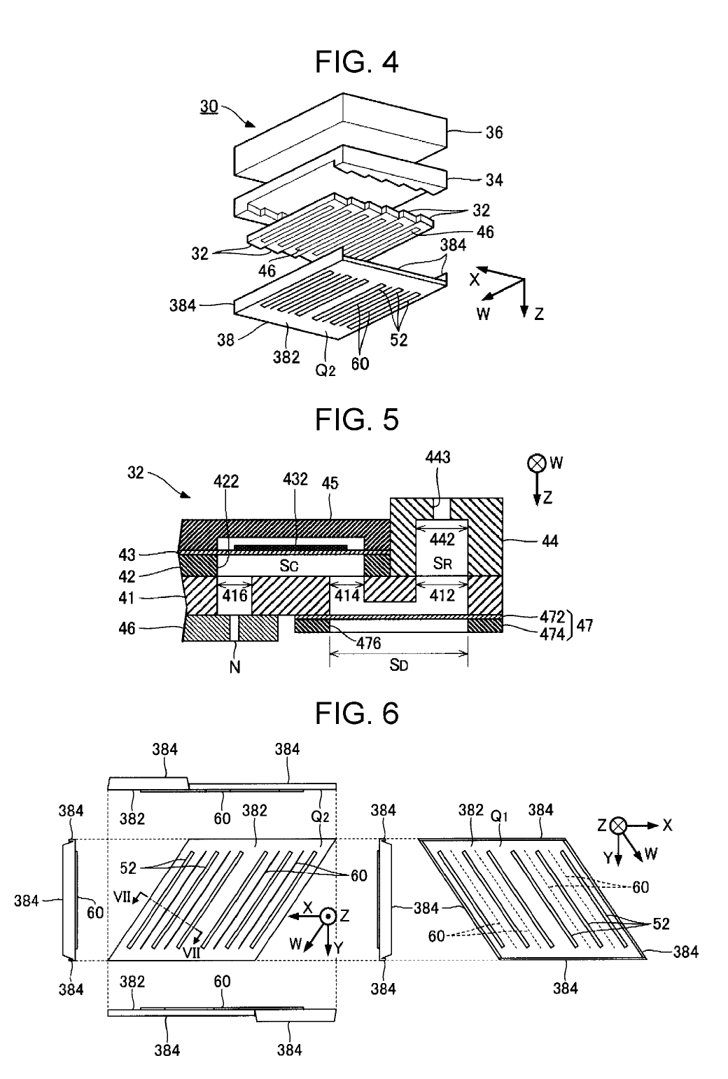

FIG. 4 is an exploded perspective view illustrating one arbitrary liquid ejecting head 30 which constitutes the liquid ejecting unit 26. As illustrated in FIG. 4, the liquid ejecting head 30 according to the first embodiment includes a plurality of (six in the first embodiment) liquid ejecting portions 32, a supporter 34, a flow path structure 36, and a fixation plate 38. The supporter 34 is a housing that accommodates and supports the plurality of liquid ejecting portions 32 and is formed through, for example, injection molding using a resin material or die casting using a metal material. The flow path structure 36 is a structure in which a flow path for distributing ink supplied from the liquid container 14 to the plurality of liquid ejecting portions 32 is formed and includes a valve structure for opening or closing the flow path or for pressure control or a filter for collecting air bubbles or foreign substances which are mixed into ink in the flow path. Note that, the supporter 34 may be integrally formed with the flow path structure 36.

Each liquid ejecting portion 32 is a head chip which ejects ink from the plurality of nozzles N. As illustrated in FIG. 3, the plurality of nozzles N of each liquid ejecting portion 32 are arranged in two rows in a W direction which intersects the X direction. As illustrated in FIG. 3, the W direction in the first embodiment is a direction which is inclined with respect to the X direction and the Y direction at a predetermined angle (for example, an angle equal to or greater than 30° and equal to or less than 60°) within the X-Y plane. In the first embodiment, as illustrated in FIG. 3, the positions of the plurality of nozzles N are selected such that a pitch (specifically, a distance between the centers of the nozzles N) PX in the X direction is narrower than a pitch PY in the Y direction (PX<PY). As described above, in the first embodiment, the plurality of nozzles N are arranged in the W direction which is inclined with respect to the Y direction in which the medium 12 is transported. Therefore, it is possible to enhance the substantial resolution (dot density) of the medium 12 in the X direction in comparison with a configuration in which the plurality of nozzles N are arranged in the X direction, for example.

FIG. 5 is a sectional view illustrating a portion of each liquid ejecting portion 32 which corresponds to one arbitrary nozzle N (a section orthogonal to the W direction). As illustrated in FIG. 5, the liquid ejecting portion 32 according to the first embodiment is a layered structure in which a pressure chamber substrate 42, a vibrating plate 43, a housing 44, and a sealing plate 45 are disposed on one side of a flow path substrate 41 (the negative side in the Z direction) and a nozzle plate 46 and a compliance portion 47 are disposed on the other side. The elements of the liquid ejecting portion 32 are approximately flat plate-shaped members which are elongated in the W direction schematically and the elements are fixed to each other via, for example, an adhesive. Note that, although FIG. 5 illustrates a portion of the liquid ejecting portion 32 which corresponds to one nozzle N for convenience, the configuration illustrated in FIG. 5 is formed to be line-symmetrical with respect to an axis of symmetry which is parallel to the W direction in fact.

The nozzle plate 46 in FIG. 5 is a substrate on which the plurality of nozzles N are formed. The nozzle plate 46 according to the first embodiment is a flat plate-shaped material which is elongated in the W direction as understood from FIG. 4 and is formed as a silicon single crystal substrate. Specifically, as illustrated in FIG. 3, the plurality of nozzles N which are arranged in two rows in the W direction are formed on the nozzle plate 46 of each liquid ejecting portion 32.

The flow path substrate 41 in FIG. 5 is a flat plate-shaped material which constitutes an ink flow path. In the flow path substrate 41 according to the first embodiment, an opening 412, a supply flow path 414, and a communication flow path 416 are formed. The supply flow path 414 and the communication flow path 416 are through holes which are formed for each nozzle N and the opening 412 is a through hole which continuously extends over the plurality of nozzles N. A space through which an accommodation portion 442 (a recess) formed in the housing 44 and the opening 412 of the flow path substrate 41 communicate with each other functions as a reserving chamber (a reservoir) SR which reserves ink, which is supplied from the liquid container 14 through an inlet flow path 443 of the housing 44.

The compliance portion 47 in FIG. 5 is an element for suppressing a fluctuation in pressure of ink in the reserving chamber SR and includes an elastic film 472 and a supporting plate 474. The elastic film 472 is a flexible member which is formed to have a film-like shape and constitutes a wall surface (specifically, a bottom surface) of the reserving chamber SR. The supporting plate 474 is a flat plate-shaped material which is formed of a material with high rigidity such as stainless steel and supports the elastic film 472 to a surface of the flow path substrate 41 such that the opening 412 of the flow path substrate 41 is closed by the elastic film 472. An opening 476 is formed in a region of the supporting plate 474 which overlaps the reserving chamber SR with the elastic film 472 interposed therebetween. When the elastic film 472 is deformed corresponding to the pressure of ink in the reserving chamber SR in a space (hereinafter, referred to as a “damper chamber”) SD in the opening 476 of the supporting plate 474, a fluctuation in pressure of ink in the reserving chamber SR is suppressed (is evened out). That is, the damper chamber SD functions as a space for deforming the elastic film 472 such that a fluctuation in pressure in the reserving chamber SR is evened out.

In the pressure chamber substrate 42 in FIG. 5, an opening 422 is formed for each nozzle N. The vibrating plate 43 is a flat plate-shaped material which can elastically vibrate and is fixed to a surface of the pressure chamber substrate 42 which is opposite to the flow path substrate 41. A space in each opening 422 of the pressure chamber substrate 42 which is interposed between the vibrating plate 43 and the flow path substrate 41 functions as a pressure chamber (cavity) SC which is filled with ink supplied from the reserving chamber SR through the supply flow path 414. Each pressure chamber SC communicates with the nozzle N through the communication flow path 416 of the flow path substrate 41. In addition, a piezoelectric element 432 is formed for each nozzle N and is formed on a surface of the vibrating plate 43 which is opposite to the pressure chamber substrate 42. Each piezoelectric element 432 is a driving element in which a piezoelectric layer is interposed between electrode layers facing each other. The plurality of piezoelectric elements 432 are sealed by the sealing plate 45.

The plurality of liquid ejecting portions 32 configured as described above are fixed to the fixation plate 38 in FIG. 4. FIG. 6 is a view (six view orthographic projection) illustrating a configuration of the fixation plate 38. As illustrated in FIGS. 4 and 6, the fixation plate 38 according to the first embodiment includes a supporting portion 382 and a plurality of peripheral edge portions 384. The supporting portion 382 is a flat plate-shaped portion which includes a first surface Q1 and a second surface Q2 which are positioned on the opposite sides. As illustrated in FIG. 6, the supporting portion 382 according to the first embodiment is formed to have a rectangular shape (specifically, a parallelogram-like shape) which is defined by a pair of edges extending in the W direction and a pair of edges extending in the X direction. The first surface Q1 of the supporting portion 382 is a surface on the negative side in the Z direction and the second surface Q2 is a surface on the positive side (the medium 12 side) in the Z direction. The second surface Q2 of the supporting portion 382 is subjected to a water-repellent process. Meanwhile, each peripheral edge portion 384 is a portion that continuously extends at each edge of the supporting portion 382 and is bent toward the negative side in the Z direction so as to be substantially orthogonal to the first surface Q1 or the second surface Q2 of the supporting portion 382. For example, the supporting portion 382 is integrally formed with the plurality of peripheral edge portions 384 by bending a flat plate-shaped material which is formed into a predetermined shape using a material with a high rigidity such as stainless steel.

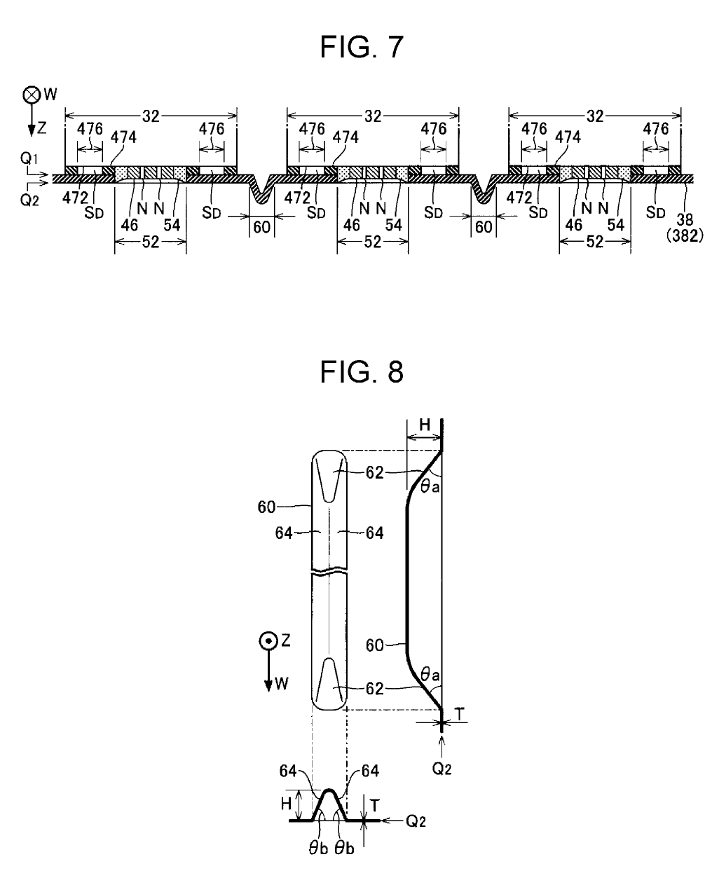

FIG. 7 is a view for explaining a relationship between the fixation plate 38 (the supporting portion 382) and each liquid ejecting portion 32 and corresponds to a sectional view taken along line VII-VII of FIG. 6. As illustrated in FIGS. 4 and 7, the plurality of liquid ejecting portions 32 of the liquid ejecting head 30 are fixed to the first surface Q1 of the supporting portion 382 of the fixation plate 38 by using an adhesive, for example. In a state where the plurality of liquid ejecting portions 32 are fixed to the first surface Q1 of the supporting portion 382 as described above, each peripheral edge portion 384 of the fixation plate 38 is fixed to the supporter 34 by using an adhesive, for example. As illustrated in FIG. 3, the plurality of liquid ejecting heads 30 configured as described above are arranged in the X direction with the second surface Q2 of the fixation plate 38 facing the positive side in the Z direction. As understood from the above description, a flat surface which is constituted by the second surfaces Q2 of the plurality of the liquid ejecting heads 30 corresponds to the ejecting surface.

As illustrated in FIGS. 6 and 7, a plurality of (six) openings 52 which correspond to different liquid ejecting portions 32 of the liquid ejecting head 30 are formed on the supporting portion 382 according to the first embodiment. The plurality of openings 52 are arranged in the X direction at predetermined intervals. Each opening 52 is an elongated through hole which extends in the W direction in plan view (as seen from a direction perpendicular to the Z direction). As illustrated in FIG. 3, each liquid ejecting portion 32 is fixed to the first surface Q1 of the supporting portion 382 in a state where the nozzle plate 46 of each liquid ejecting portion 32 is positioned in one opening 52. As understood from the above description, each opening 52 of the fixation plate 38 is a through hole for exposing the plurality of nozzles N of each liquid ejecting portion 32. As illustrated in FIG. 7, a space in the opening 52 (specifically, a gap between an inner peripheral surface of the opening 52 and an outer peripheral surface of the nozzle plate 46) is filled with a filler 54 which is formed of a resin material, for example. Accordingly, there is an advantage that it is possible to reduce a possibility of a large amount of ink intruding into or remaining in the space in the opening 52 in comparison with a configuration in which the filler 54 is not formed. Meanwhile, in a configuration in which the filler 54 is formed of a hydrophilic resin material, ink ejected from each nozzle N is likely to adhere to a surface of the filler 54.

As illustrated in FIG. 7, in the first embodiment, a surface of the supporting plate 474 of the compliance portion 47 which is opposite to the elastic film 472 is fixed to the first surface Q1 of the fixation plate 38 via an adhesive, for example. That is, the opening 476 of the supporting plate 474 is closed by the first surface Q1 of the fixation plate 38. A space in the opening 476 of the supporting plate 474 which is interposed between the elastic film 472 and the first surface Q1 functions as the damper chamber SD for vibrating the elastic film 472.

As illustrated in FIGS. 6 and 7, a plurality of protrusions 60 are installed on the supporting portion 382 of the fixation plate 38. Each protrusion 60 protrudes from the second surface Q2 of the fixation plate 38 toward the positive side in the Z direction (the medium 12 side). As illustrated in FIG. 3, the plurality of protrusions 60 according to the first embodiment are installed in the region R in the ejecting surface in which the plurality of nozzles N are distributed. Specifically, each protrusion 60 is formed in a region between the openings 52 which are adjacent to each other in the X direction and each protrusion 60 extends in the W direction as with each opening 52. That is, each protrusion 60 is formed to be elongated (linearly) such that a dimension thereof in the W direction exceeds a dimension thereof in a direction orthogonal to the W direction within the X-Y plane. The dimension (entire length) of the protrusion 60 in the W direction is the same as the dimension of the opening 52 in the W direction. As understood from FIG. 6, no protrusion 60 is formed on a region of the supporting portion 382 of the fixation plate 38 which is positioned between each peripheral edge portion 384 (each edge of the supporting portion 382) and the opening 52. Therefore, it is possible to reduce a possibility of an error in position of the opening 52 and the protrusion 60 and an error in positional relationship between the opening 52 and the protrusion 60 which are attributable to bending of the peripheral edge portion 384. In addition, there is an advantage that it is easy to bend the peripheral edge portion 384 in comparison with a configuration in which the protrusion 60 is formed between the peripheral edge portion 384 and the opening 52.

Each protrusion 60 according to the first embodiment is integrally formed with the fixation plate 38. Specifically, each protrusion 60 is formed through drawing with respect to the fixation plate 38. FIG. 8 is an enlarged view illustrating one arbitrary protrusion 60. As illustrated in FIG. 8, the protrusion 60 is a three-dimensional structure including end surfaces 62 which are positioned on opposite end sides in the W direction (that is, a longitudinal direction of the protrusion 60) and side surfaces 64 which are positioned between the opposite ends. An apex portion of the protrusion 60 at which the side surfaces 64 intersect each other is formed to have a curved surface-like shape. In FIG. 8, both of a section parallel to the W direction and a section perpendicular to the W direction are illustrated. As understood from each sectional view, an angle θa between the second surface Q2 and the end surface 62 of the protrusion 60 is smaller than an angle θb between the second surface Q2 and the side surface 64 of the protrusion 60. That is, each end surface 62 of the protrusion 60 is an inclined surface which is gentle in comparison with the side surface 64.

As illustrated in FIG. 8, the height H of the protrusion 60 with respect to the second surface Q2 is substantially constant over the entire length in the W direction except for an area of the end surface 62. Specifically, the height H is maintained at a predetermined value over an area of 90% or more of the entire length of the protrusion 60 in the W direction. As illustrated in FIG. 8, the height H of the protrusion 60 is larger than the plate thickness T of the fixation plate 38 (the supporting portion 382) (H>T). Specifically, the height H of the protrusion 60 is approximately 0.4 mm to 0.6 mm while the plate thickness T of the fixation plate 38 is approximately 0.08 mm. In addition, since the second surface Q2 of the fixation plate 38 is subjected to the water-repellent process as described above, a surface of each protrusion 60 formed on the second surface Q2 (each end surface 62 and each side surface 64) is also water-repellent. Accordingly, there is an advantage that it is possible to reduce a possibility of ink remaining on a surface of the protrusion 60.

As illustrated in FIG. 7, each liquid ejecting portion 32 is installed on a position which does not overlap each protrusion 60 in plan view. Specifically, the supporting plate 474 of the liquid ejecting portion 32 which is bonded to the first surface Q1 of the fixation plate 38 does not overlap each protrusion 60 on the second surface Q2 side in plan view. In addition, the damper chamber SD of each protrusion 60 does not overlap each protrusion 60 in plan view. In a configuration in which the damper chamber SD of each protrusion 60 overlaps each protrusion 60 in plan view, the damper chamber SD communicates with a space in the protrusion 60 and there is a possibility of error in characteristic (volume or pressure) of the damper chamber SD. In the first embodiment, since each protrusion 60 does not overlap the damper chamber SD in plan view, it is possible to make characteristics of each damper chamber SD even.

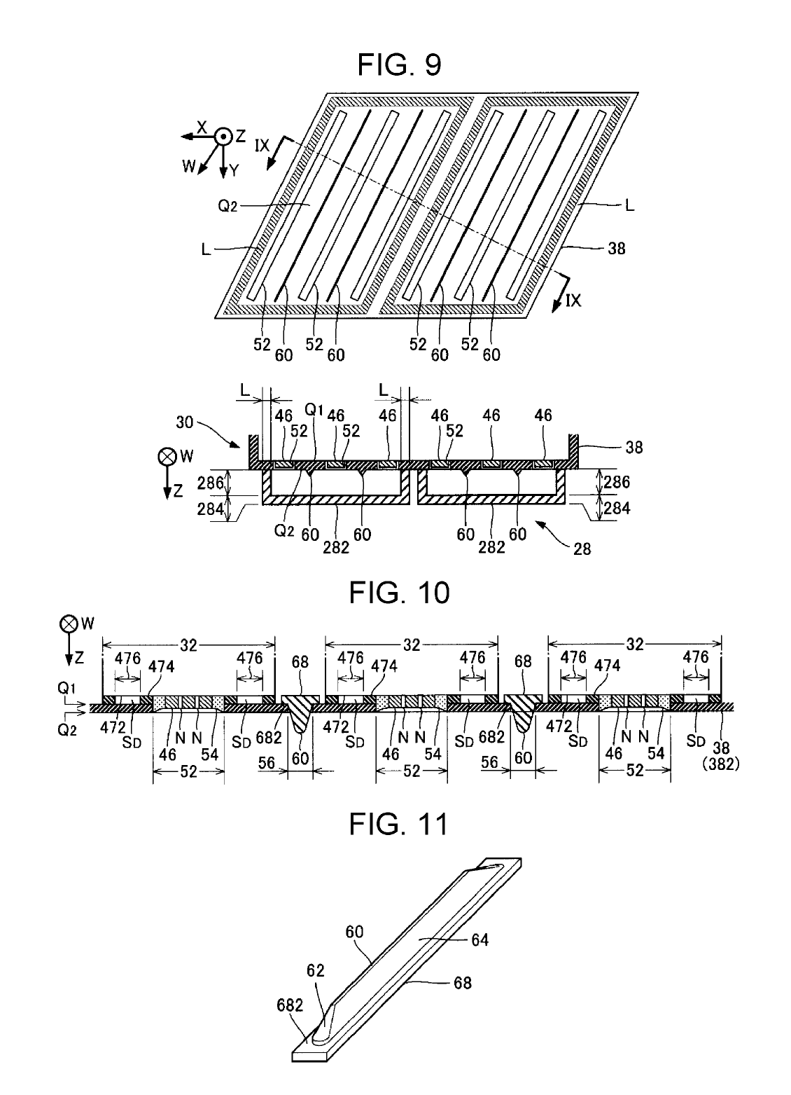

The printing apparatus 10 according to the first embodiment includes a sealing mechanism (a cap) 28 in FIG. 9. FIG. 9 illustrates both of the second surface Q2 of the fixation plate 38 and a sectional view taken along line IX-IX. As understood from the sectional view in FIG. 9, the sealing mechanism 28 according to the first embodiment includes a plurality of sealing bodies 282 which come into contact with the second surface Q2 (the ejecting surface) of the fixation plate 38 and air-tightly close each nozzle N during a maintenance operation such as cleaning of the plurality of nozzles N. In the first embodiment, it is assumed that two sealing bodies 282 are used for one liquid ejecting head 30. Each sealing body 282 is an elastic material in which a base portion 284 is integrally formed with a sealing portion 286 and is formed through injection molding using a resin material.

The base portion 284 is a flat plate-shaped portion and the sealing portion 286 is an annular portion (specifically, a rectangular frame-shaped portion) which protrudes from a peripheral edge of the base portion 284. When a top surface of the sealing portion 286 which is opposite to the base portion 284 abuts onto the second surface Q2 of the fixation plate 38, each nozzle N is air-tightly closed. As illustrated in FIG. 9, the plurality of protrusions 60 of the fixation plate 38 are formed in a region on the second surface Q2 other than an annular region (hereinafter, referred to as a “sealed region”) L which comes into contact with the sealing body 282 so that the plurality of protrusions 60 do not overlap the sealed region L in plan view. Specifically, the plurality of protrusions 60 are formed in a region on the second surface Q2 which is on the inside of an inner peripheral edge of the sealed region L in plan view (a region surrounded by the sealed region L). As described above, in the first embodiment, since no protrusion 60 is formed in the sealed region L on the second surface Q2 of the fixation plate 38, there is an advantage that it is possible to sufficiently air-tightly close each nozzle N by bring the sealing body 282 (the sealing portion 286) into close contact with the second surface Q2 in comparison with a configuration in which the protrusion 60 is formed in the sealed region L.

As understood from the above description, in the first embodiment, since the protrusion 60 which protrudes from the second surface Q2 of the fixation plate 38 toward the positive side in the Z direction (the medium 12 side) is formed, the medium 12 which is deformed (for example, curls) toward the liquid ejecting unit 26 side between the first roller 242 and the second roller 244 as illustrated by using the broken line in FIG. 2 comes into contact with the protrusion 60 before reaching the second surface Q2 of the fixation plate 38, for example. Accordingly, it is possible to reduce a possibility of adhering of ink remaining on a surface in the vicinity of the opening 52 (particularly, the filler 54) of the fixation plate 38 to the medium 12.

Incidentally, the closer the protrusion 60 is to the opening 52, the more unlikely ink remaining in the opening 52 is to adhere to the medium 12. In the first embodiment, since the protrusion 60 is formed on the fixation plate 38 to which the liquid ejecting portion 32 is fixed, a distance between the opening 52 of the fixation plate 38 and the protrusion 60 is short in comparison with a configuration in which the protrusion 60 is formed on an element other than the fixation plate 38. Accordingly, the above-described effect that it is possible to reduce a possibility of adhering of ink remaining in the opening 52 to the medium 12 becomes particularly significant. Meanwhile, the short distance between the opening 52 of the fixation plate 38 and the protrusion 60 means that the height H of the protrusion 60 required to prevent the adhering of ink in the opening 52 to the medium 12 is reduced. Accordingly, there is an advantage that a gap that needs to be provided between the medium 12 and the fixation plate 38 (a so-called platen gap) is shortened and thus an error in landing position of ink with respect to a surface of the medium 12 is reduced.

In addition, as described above, the fixation plate 38 according to the first embodiment is fixed to the nozzle plate 46 via members other than the nozzle plate 46 (specifically, the flow path substrate 41 and the compliance portion 47). That is, both of the fixation plate 38 and the nozzle plate 46 are disposed on one side of the flow path substrate 41 (the positive side in the Z direction). Therefore, there is an advantage that a gap between the medium 12 and the nozzle plate 46 is shortened and thus an error in landing position of ink with respect to a surface of the medium 12 is reduced in comparison with a configuration in which the fixation plate 38 is directly bonded to a surface of the nozzle plate 46, for example. In addition, since the plurality of liquid ejecting portions 32 are fixed to the same fixation plate 38, there is an advantage that it is possible to adjust a positional relationship between the liquid ejecting portions 32 with high accuracy in comparison with a configuration in which each liquid ejecting portion 32 is fixed to an individual member, for example.

In the first embodiment, since the height H of the protrusion 60 is larger than the plate thickness T of the fixation plate 38 (the supporting portion 382) (H>T), there is an advantage that it is possible to effectively prevent contact between the second surface Q2 of the fixation plate 38 and the medium 12 in comparison with a configuration in which the height H of the protrusion 60 is smaller than the plate thickness T of the fixation plate 38. Furthermore, it is possible to suppress ink adhering to a surface of the filler 54 which fills the gap between the inner peripheral surface of the opening 52 and the outer peripheral surface of the nozzle plate 46 while reducing the gap (the volume of a space between both).

In the first embodiment, a configuration, in which the plurality of protrusions 60 are formed in the region on the inside of the inner peripheral edge of the sealed region L on the second surface Q2 in plan view, contributes to reduction in distance between the opening 52 of the fixation plate 38 and the protrusion 60. Accordingly, it is possible to reduce a possibility of adhering of ink remaining in the opening 52 to the medium 12 in comparison with a configuration in which the protrusion 60 is formed to continuously extend at the peripheral edge portion 384 of the fixation plate 38, for example.

Note that, in a configuration in which the angle θa between the protrusion 60 and the end surface 62 is steep (for example, is close to a right angle), there is a possibility of a leading end of the medium 12 being engaged with a corner portion at which the end surface 62 and the second surface Q2 intersect each other while causing deformation of the medium 12 such as wrinkles. In the first embodiment, since the angle θa of the end surface 62 is made smaller than the angle θb of the side surface 64, there is an advantage that it is possible to reduce a possibility of the leading end of the medium 12 being engaged with the end surface 62 (in addition, a possibility of deformation of the medium 12).

### Second Embodiment

A second embodiment of the invention will be described below. Note that, elements in embodiments described below which have the same effect and function as those in the first embodiment are denoted by the same reference numerals used in the description of the first embodiment and detailed descriptions thereof are appropriately omitted.

FIG. 10 is a view for explaining a relationship between the fixation plate 38 and each liquid ejecting portion 32 according to the second embodiment and corresponds to FIG. 7 of the first embodiment. In the first embodiment, a configuration in which the protrusion 60 is integrally formed with the fixation plate 38 has been described. However, in the second embodiment, as illustrated in FIG. 10, the protrusion 60 which is formed separately from the fixation plate 38 is fixed to the fixation plate 38.

FIG. 11 is a perspective view of the protrusion 60 according to the second embodiment. Note that, FIGS. 10 and 11 illustrate the protrusions 60 facing vertically opposite directions. As illustrated in FIG. 11, the protrusion 60 according to the second embodiment is integrally formed with the elongated bonded portion 68 through injection molding using a resin material, for example, and protrudes from a surface 682 of the bonded portion 68. The shape and dimensions of the protrusion 60 are the same as those in the first embodiment.

Meanwhile, as illustrated in FIG. 10, in the fixation plate 38 according to the second embodiment, a through hole 56 which extends in the W direction is formed for each protrusion 60. The transverse width of the through hole 56 is larger than the transverse width of the protrusion 60 and is smaller than the transverse width of the bonded portion 68. As illustrated in FIG. 10, the bonded portion 68 is fixed to the first surface Q1 of the fixation plate 38. Specifically, the surface 682 of the bonded portion 68 on which the protrusion 60 is formed is fixed to the first surface Q1 via, for example, an adhesive such that the bonded portion 68 does not overlap the liquid ejecting portion 32 in plan view. In a state where the surface 682 of the bonded portion 68 is fixed to the first surface Q1, the protrusion 60 protrudes toward the second surface Q2 side through the through hole 56.

As described above, in the second embodiment also, since the protrusion 60 which protrudes from the second surface Q2 of the fixation plate 38 toward the positive side in the Z direction (the medium 12 side) is formed, the same effect as in the first embodiment is realized. Note that, the fixation plate 38 may be deformed due to a stress generated when the protrusion 60 is formed in the first embodiment in which the protrusion 60 is formed through the drawing with respect to the fixation plate 38. However, in the second embodiment, since the protrusion 60 which is formed separately from the fixation plate 38 is fixed to the fixation plate 38 (therefore, the drawing of the fixation plate 38 is not necessary), there is an advantage that it is easy to maintain the flatness of the fixation plate 38 and to manufacture the fixation plate 38 with high flatness in comparison with the first embodiment. Meanwhile, in the first embodiment, since the protrusion 60 is integrally formed with the fixation plate 38, a decrease in number of components of the liquid ejecting head 30 and simplification of a manufacturing step (omission of a step of bonding the separate protrusion 60 to the fixation plate 38) are realized.

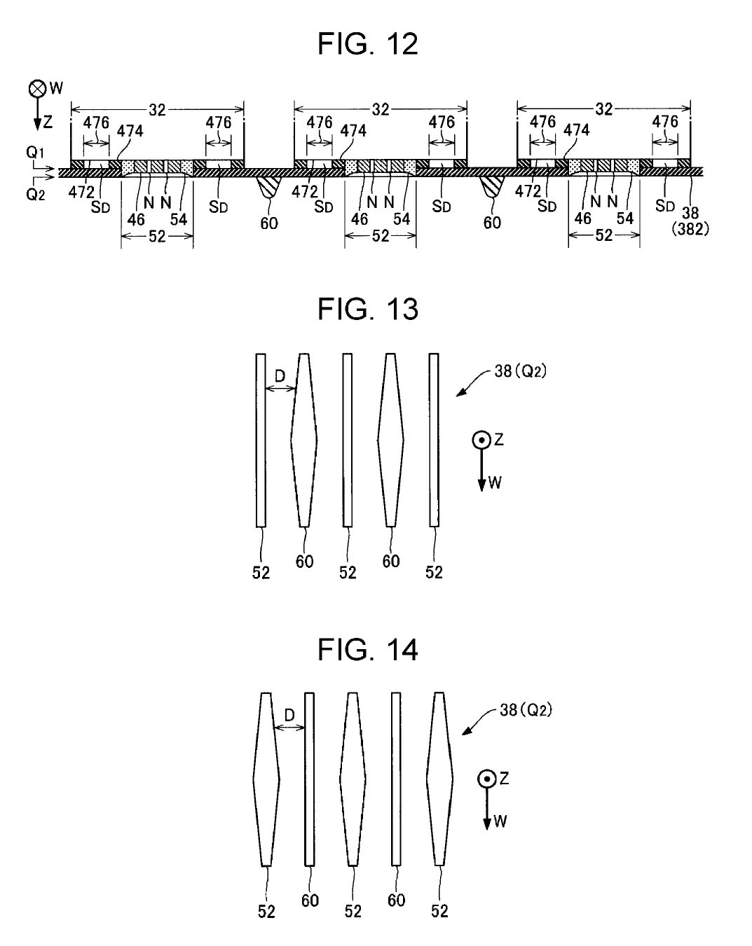

Note that, in the second embodiment, a configuration in which the bonded portion 68 on which the protrusion 60 is installed is bonded to the first surface Q1 of the fixation plate 38 has been described. However, the same effect as in the second embodiment is realized even in a configuration in which the protrusion 60 which is formed separately from the fixation plate 38 is bonded to the second surface Q2 of the fixation plate 38 as illustrated in FIG. 12. In addition, in the configuration illustrated in FIG. 12, since it is possible to secure a sufficient area for bonding the protrusion 60, there is an advantage that it is easy to secure mechanical strength of the protrusion 60 (it is possible to prevent falling-off or the like of the protrusion 60 which is attributable to collision with the medium 12) in comparison with the second embodiment. Meanwhile, in the second embodiment, since the bonded portion 68 on which the protrusion 60 is installed is bonded to the first surface Q1 of the fixation plate 38, there is an advantage that an adhesive used for installation of the protrusion 60 is unlikely to protrude onto a surface of the second surface Q2 (it is possible to reduce a possibility of the nozzle N being closed by the adhesive adhering thereto) in comparison with the configuration illustrated in FIG. 12.

### Third Embodiment

FIG. 13 is a plan view illustrating the second surface Q2 of the fixation plate 38 according to a third embodiment. In the first and second embodiments, the linear protrusion 60 of which the transverse width is maintained to be constant over the substantially entire portion in the W direction has been described. In the third embodiment, as illustrated in FIG. 13, the transverse width of the protrusion 60 varies according to the position in the W direction. Specifically, each protrusion 60 is formed into a shape in which the transverse width increases toward the central portion from opposite end portions in the W direction. Meanwhile, each opening 52 is formed into a rectangular shape which is elongated in the W direction as with the first embodiment. Accordingly, in the third embodiment, a gap D between the central portion of the protrusion 60 and the opening 52 in a direction orthogonal to the W direction is smaller than the gap D between the end portion of the protrusion 60 and the opening 52 in the direction orthogonal to the W direction. That is, the gap D between the protrusion 60 and the opening 52 becomes the smallest at the central portion of the protrusion 60.

As described above, the closer the protrusion 60 is to the opening 52, the more unlikely ink remaining in the opening 52 is to adhere to the medium 12. Accordingly, in the third embodiment, an effect of the protrusion 60 that prevents adhering of ink remaining in the opening 52 to the medium 12 is great at the central portion in comparison with the opposite ends of the protrusion 60 as long as the gap D between the protrusion 60 and the opening 52 satisfies the above-described relationship. Note that, in formation of the protrusion 60 according to the third embodiment, a method of integrally forming the protrusion 60 with the fixation plate 38 as in the first embodiment or a method of forming the protrusion 60 separately from the fixation plate 38 and fixing the protrusion 60 to the fixation plate 38 as in the second embodiment may be used.

The same effect as in the first embodiment is realized in the third embodiment also. Incidentally, the medium 12 is likely to be deformed at a point in the vicinity of a central portion of the ejecting surface in the W direction since the point is distant from the first roller 242 and the second roller 244 which support the medium 12 (that is, an effect of suppressing deformation of the medium 12 is relatively small). In the third embodiment, since the gap D between the protrusion 60 and the opening 52 at the central portion of the protrusion 60 is larger than the gap D at the opposite end portions, there is an advantage that it is possible to effectively suppress deformation of the medium 12 which is likely to occur particularly at the central portion of the protrusion 60.

### Modification Example of Third Embodiment

In FIG. 13, a configuration in which the transverse width of the central portion of the protrusion 60 is larger than that of the opposite end portions has been described. However, a configuration for decreasing the gap D between the protrusion 60 and the opening 52 in the direction orthogonal to the W direction toward the center of the protrusion 60 in the W direction is not limited to the above-described example. For example, a configuration in which the transverse width (a dimension in the direction orthogonal to the W direction) of the opening 52 varies according to the position in the W direction as illustrated in FIG. 14 may be used. Specifically, each opening 52 is formed to have a flat surface-like shape in which the transverse width increases toward the central portion from the opposite end portions in the W direction. In the configuration illustrated in FIG. 14, the same effect as in the third embodiment is realized since the gap D between the protrusion 60 and the opening 52 decreases toward the center of the protrusion 60.

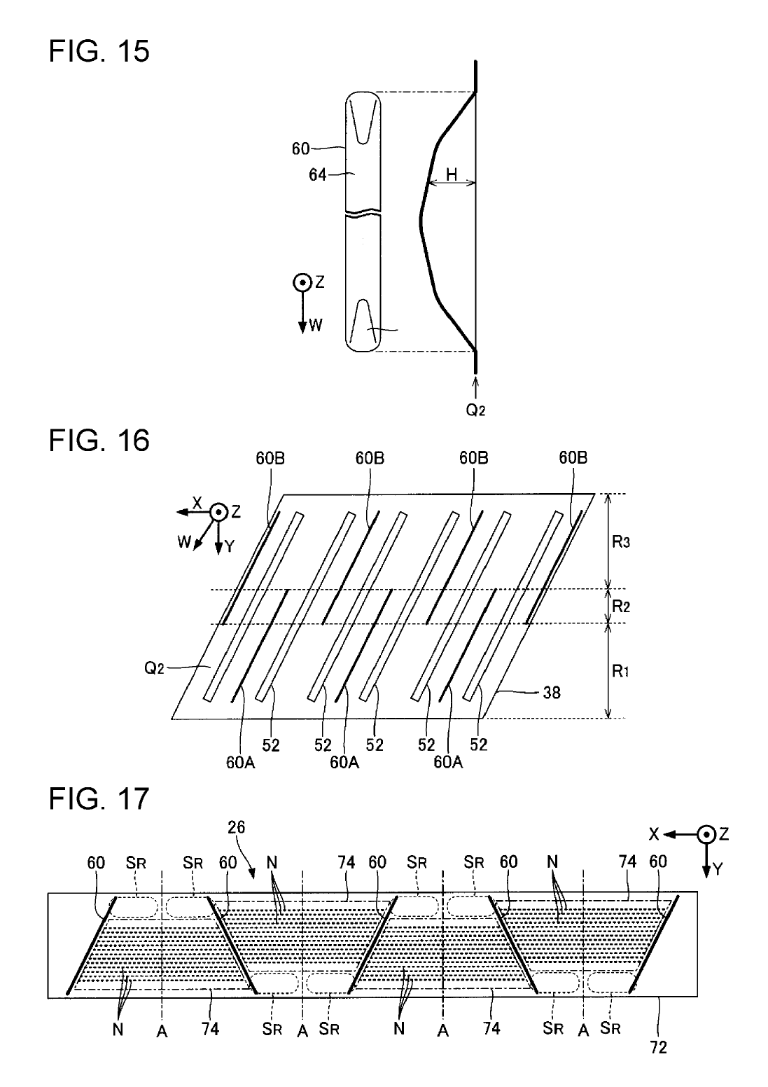

In addition, in the third embodiment, it has been assumed that the closer the protrusion 60 is to the opening 52, the more unlikely ink in the opening 52 is to adhere to the medium 12. Similarly, the larger the height H of the protrusion 60 with respect to the second surface Q2, the more unlikely ink in the opening 52 is to adhere to the medium 12. In consideration of the latter fact, each protrusion 60 may be formed such that the height H of the central portion of the protrusion 60 is larger than the heights H of the opposite end portions of the protrusion 60 as illustrated in FIG. 15, for example. The same effect as in the third embodiment is realized even in the configuration illustrated in FIG. 15.

### Fourth Embodiment

FIG. 16 is a plan view illustrating the second surface Q2 of the fixation plate 38 according to a fourth embodiment. As illustrated in FIG. 16, the plurality of protrusions 60 formed on the fixation plate 38 according to the fourth embodiment include a plurality of first protrusions 60A and a plurality of second protrusions 60B. The plurality of first protrusions 60A are arranged in the X direction at predetermined intervals and each of the plurality of first protrusions 60A extends in the W direction. Similarly, the plurality of second protrusions 60B are arranged in the X direction at predetermined intervals and each of the plurality of second protrusions 60B extends in the W direction. The first protrusions 60A and the second protrusions 60B are alternately arranged in the X direction.

As illustrated in FIG. 16, the second surface Q2 (the region R) of the fixation plate 38 according to the fourth embodiment is divided into a first region R1, a second region R2, and a third region R3 in the Y direction for convenience. The first region R1 is positioned on the positive side in the Y direction of the second region R2 and the third region R3 is positioned on the negative side in the Y direction of the second region R2. The first protrusion 60A extends in the W direction over the first region R1 and the second region R2 and is not formed in the third region R3. Meanwhile, the second protrusion 60B extends in the W direction over the second region R2 and the third region R3 and is not formed in the first region R1. As understood from the above description, in the fourth embodiment, the first protrusion 60A and the second protrusion 60B are different in position in the Y direction in which the medium 12 is transported and partially overlap each other in the Y direction (that is, overlap each other only in the second region R2). Note that, in formation of each protrusion 60, a method of integrally forming the protrusion 60 with the fixation plate 38 as in the first embodiment or a method of forming the protrusion 60 separately from the fixation plate 38 and fixing the protrusion 60 to the fixation plate 38 as in the second embodiment may be used.

The same effect as in the first embodiment is realized in the fourth embodiment also. In addition, in the fourth embodiment, since the protrusion 60 is shortened in comparison with a configuration in which the protrusion 60 extends in the W direction over the entire area on the second surface Q2, there is an advantage that it is possible to suppress deformation of the fixation plate 38 which is attributable to formation of the protrusion 60 (particularly deformation pertaining to a case where the protrusion 60 is formed through drawing). Note that, in a configuration in which the first protrusion 60A and the second protrusion 60B do not overlap each other in the Y direction (a configuration in which none of the first protrusion 60A and the second protrusion 60B is formed in the second region R2), since the medium 12 comes into contact with the second surface Q2 of the fixation plate 38 at the second region R2 in FIG. 16, ink remaining in the opening 52 may adhere to the medium 12. In the fourth embodiment, since the first protrusion 60A and the second protrusion 60B partially overlap each other in the Y direction, there is an advantage that it is possible to effectively prevent the contact between the second surface Q2 and the medium 12 although the length of each protrusion 60 is made short.

### Fifth Embodiment

FIG. 17 is a plan view illustrating the ejecting surface of the liquid ejecting unit 26 according to a fifth embodiment which faces the medium 12. As illustrated in FIG. 17, the liquid ejecting unit 26 according to the fifth embodiment is a line head elongated in the X direction which includes a nozzle plate 72 which faces the medium 12. The nozzle plate 72 is a flat plate-shaped material which is elongated in the X direction over the entire width of the medium 12.

As illustrated in FIG. 17, a plurality of regions 74, which are arranged in the X direction, are defined on the nozzle plate 72. Each region 74 is a trapezoid-shaped (specifically, isosceles trapezoid-shaped) region in plan view. The plurality of regions 74 are defined such that the regions 74 which are adjacent to each other in the X direction are opposite to each other in positional relationship between the upper base and the lower base. In each region 74, the plurality of nozzles N are formed in the X direction and the Y direction. As understood from the above description, a surface of the nozzle plate 72 which is positioned on the positive side in the Z direction (a surface facing the medium 12) functions as the ejecting surface on which the plurality of nozzles N are installed.

As illustrated in FIG. 17, the plurality of protrusions 60 are formed on the ejecting surface of the nozzle plate 72 according to the fifth embodiment. Each protrusion 60 is formed along a direction (a second direction) intersecting the X direction and protrudes from the ejecting surface. Specifically, the linear protrusion 60 is formed in a direction along each leg of the trapezoid within a gap between the regions 74 which are adjacent to each other in the X direction. That is, each protrusion 60 according to the fifth embodiment extends in a direction which is inclined with respect to the X direction. As illustrated in FIG. 17, the protrusions 60 which are adjacent to each other in the X direction are line-symmetric with respect to an axis A which is orthogonal to the X direction.

The shape of each protrusion 60 is the same as that in the abode-described embodiments. In addition, in formation of each protrusion 60, a method of integrally forming the protrusion 60 with the nozzle plate 72 through drawing with respect to the nozzle plate 72, for example or a method of fixing the protrusion 60 which is formed separately from the nozzle plate 72 to the ejecting surface of the nozzle plate 72 may be used.

As illustrated in FIG. 17, the liquid ejecting unit 26 according to the fifth embodiment includes a plurality of reserving chambers SR. As with the first embodiment, each reserving chamber SR is a space for reserving ink to be ejected from the plurality of nozzles N. Specifically, the reserving chamber SR is formed at a position corresponding to the apex of each region 74 in plan view (as seen from a direction perpendicular to the ejecting surface). Ink which is distributed from the reserving chamber SR into a plurality of flow paths is ejected from each nozzle N. As understood from FIG. 17, each protrusion 60 according to the fifth embodiment is installed on a position which overlaps the reserving chamber SR in plan view. Meanwhile, each nozzle N is formed on a position which does not overlap the reserving chamber SR in plan view. As described above, in the fifth embodiment, since the region on the ejecting surface which overlaps the reserving chamber SR in plan view (a region in which the nozzle N is not formed inherently) is effectively used for formation of the protrusion 60, it is possible to arrange the plurality of nozzles N at a high density in comparison with a configuration in which the protrusion 60 is formed not to overlap the reserving chamber SR.

In the above-described fifth embodiment, the protrusion 60 that protrudes from the ejecting surface on which the plurality of nozzles N are arranged is installed along the direction intersecting (is orthogonal to or is inclined with respect to) the X direction which is a longitudinal direction of the line head. Therefore, there is an advantage that it is possible to prevent the contact between the ejecting surface and the medium 12 over a wide range in the Y direction in which the medium 12 is transported in comparison with a configuration in which the protrusion 60 is formed along the X direction.

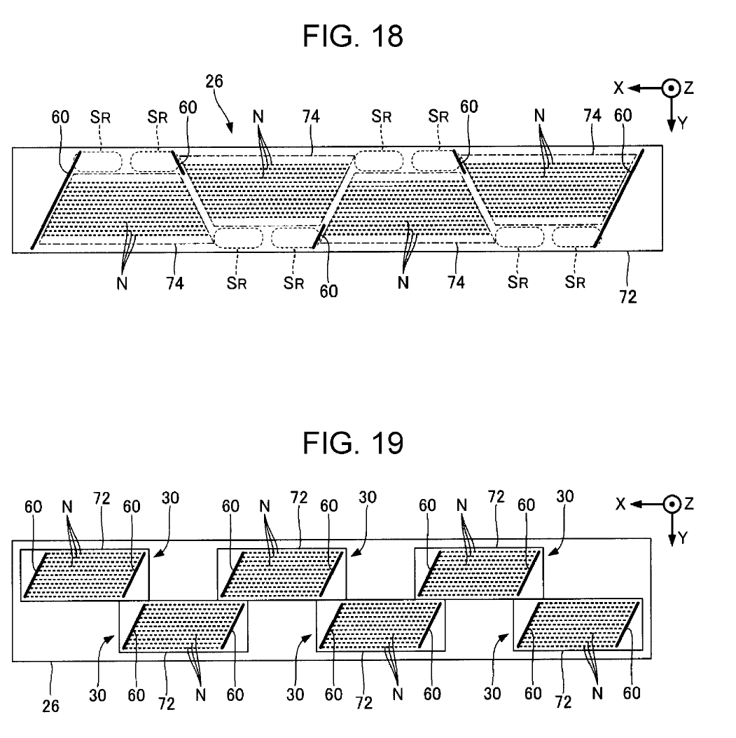

In FIG. 17, a configuration in which the protrusion 60 extends over the entire length of the gap between the regions 74 which are adjacent to each other in the X direction has been described. However, for example, the protrusion 60 may be formed only on a portion of the gap between the regions 74 as illustrated in FIG. 18. In the configuration illustrated in FIG. 18, since there is no need to secure a space for forming the protrusion 60 in a gap between the regions 74, there is an advantage that it is possible to dispose the plurality of nozzles N at high density while disposing the regions 74 to be close to each other.

### Sixth Embodiment

FIG. 19 is a plan view illustrating the ejecting surface of the liquid ejecting unit 26 according to a sixth embodiment which faces the medium 12. As illustrated in FIG. 19, the liquid ejecting unit 26 according to the sixth embodiment includes the plurality of liquid ejecting heads 30 which are zigzag-arranged (so called staggered arrangement) in the X direction. Each of the plurality of liquid ejecting heads 30 includes the nozzle plate 72 on which the plurality of nozzles N are formed within the X-Y plane. The plurality of protrusions 60 are formed on the ejecting surface of the nozzle plate 72 of each liquid ejecting head 30 which faces the medium 12. Each protrusion 60 is formed along a direction intersecting (is orthogonal to or is inclined with respect to) the X direction and protrudes from the ejecting surface. The shape and the formation method of each protrusion 60 are the same as in the above-described embodiments. The same effect as in the above-described embodiments is realized in the sixth embodiment also.

The above-described first to sixth embodiments are expressed as a configuration, in which the protrusion 60 which protrudes from the ejecting surface on which the plurality of nozzles N are installed is installed, in a comprehensive manner and the function and purpose of use of a member forming the ejecting surface are not considered. The invention is applied to various configurations (for example, the shape of the protrusion 60 or the like) described in the above-described embodiments in the same manner regardless of whether the ejecting surface is formed by using the fixation plate 38 as in the first to fourth embodiments or the ejecting surface is formed by using the nozzle plate 72 as in the fifth and sixth embodiments.

### Modification Example

The embodiments described above can be variously modified. Specific modification embodiments will be exemplified below. Two or more embodiments arbitrarily selected from the following examples can be appropriately combined with each other as long as there is no contradiction.

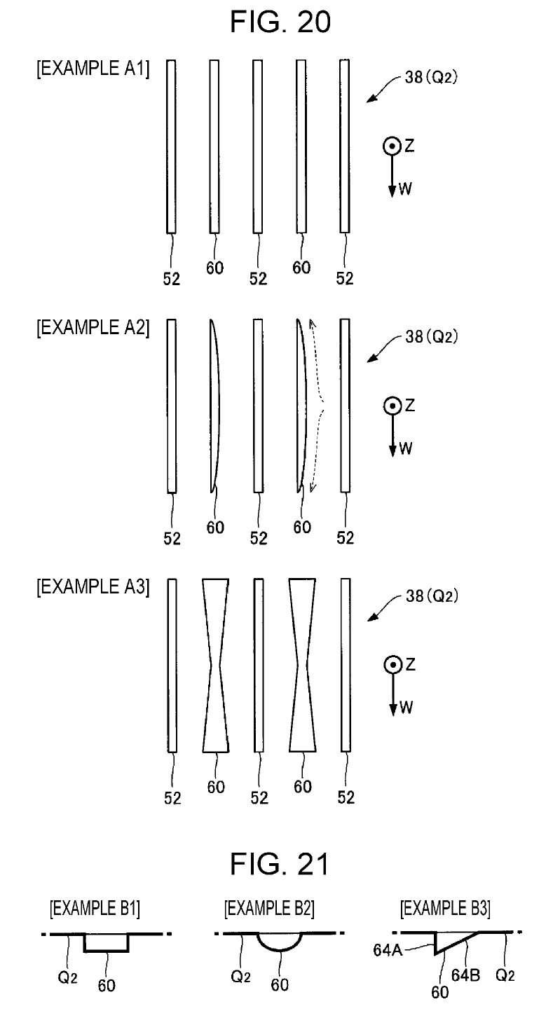

(1) The planar shape of the protrusion 60 (the external shape of the protrusion 60 as seen from the Z direction) is not limited to those described in the above-described embodiments. For example, the protrusion 60 with a planar shape described in FIG. 20 may be formed on the ejecting surface (the second surface Q2). The planar shape of the protrusion 60 in Example A1 is a rectangular shape (an oblong-like shape) and the planar shape of the protrusion 60 of Example A2 is a bow-like shape (a crescentic shape). In a configuration of Example A2, in a case where ink on the ejecting surface is wiped out by moving a wiper (not shown) being in contact with the ejecting surface (the second surface Q2) in a direction perpendicular to the W direction (a leftward direction in FIG. 20), ink pressurized by the wiper moves toward the positive side and the negative side in the X direction along the side surface of the protrusion 60 as illustrated by using broken arrows in FIG. 20. Therefore, there is an advantage that the amount of ink remaining (unwiped) on the ejecting surface decreases. The same effect as described above is realized in a configuration in which the protrusion 60 is formed to have a planar shape in which the transverse width of the central portion is larger than that of the opposite end portions as described in FIG. 13. In addition, the protrusion 60 may be formed to have a planar shape in which the transverse width of the central portion is smaller than that of the opposite end portions as in Example A3 in FIG. 20. In addition, a configuration in which the plurality of protrusions 60 are arranged in the W direction may also be used.

(2) The sectional shape of the protrusion 60 (the shape of a surface of the protrusion 60 in a section perpendicular to the W direction) is not limited to those described in the above-described embodiments. For example, the protrusion 60 with a sectional shape described in FIG. 21 may be formed on the ejecting surface (the second surface Q2). The sectional shape of the protrusion 60 in Example B1 is a rectangular shape (an oblong-like shape) and the sectional shape of the protrusion 60 of Example B2 is a bow-like shape. Note that, the sectional shape of the protrusion 60 is not limited to a line-symmetric shape. For example, the protrusion 60 may be formed to have a triangular sectional shape which is formed by a side surface 64A perpendicular to the ejecting surface (the second surface Q2) and a side surface 64B inclined with respect to the ejecting surface as in Example B3 in FIG. 21. Note that, in a configuration in which the protrusion 60 includes a surface inclined with respect to the ejecting surface as in the above described embodiments or Example B2 and Example B3 in FIG. 21, there is an advantage that it is possible to effectively wipe out ink adhering to the ejecting surface by using a wiper in comparison with a configuration in Example B1 in FIG. 21, for example.

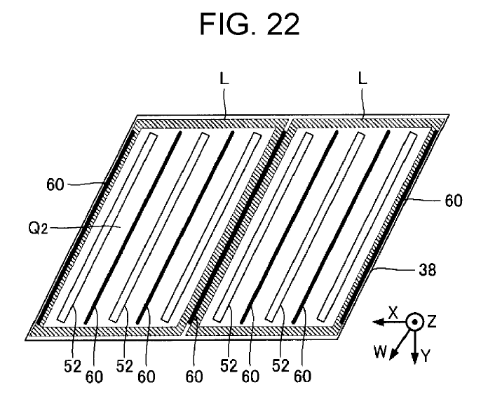

(3) In the above-described embodiments, the protrusion 60 is formed in the region other than the sealed region L on the ejecting surface of the fixation plate 38 which comes into contact with each sealing body 282 of the sealing mechanism 28. However, a configuration in which at least a portion of the protrusion 60 overlaps the sealed region L in plan view as illustrated in FIG. 22 may also be used. FIG. 22 illustrates a configuration in which each protrusion 60, which is positioned on the opposite end portions in the X direction, of six protrusions 60 formed on one fixation plate 38 overlaps a region in the sealed region L which extends in the W direction in plan view. In a configuration in which the protrusion 60 overlaps the sealed region L, it is possible to form the plurality of protrusions 60 on the fixation plate 38 regardless of the shape and the size of the sealed region L. Accordingly, there is an advantage that it is possible to effectively prevent the contact between the ejecting surface and the medium 12 in comparison with a configuration in which the protrusion 60 is formed in a region other than the sealed region L.

(4) In the first to fourth embodiments, the supporting plate 474 of the compliance portion 47 in each liquid ejecting portion 32 is fixed to the first surface Q1 of the fixation plate 38. However, a member of the liquid ejecting portion 32 which is bonded to the fixation plate 38 is not limited to the supporting plate 474. For example, in a configuration in which the compliance portion 47 is installed at a place other than a surface of the liquid ejecting portion 32 which faces the fixation plate 38 or in a configuration in which the compliance portion 47 is omitted, it is also possible to fix a surface of the flow path substrate 41 on the positive side in the Z direction to the first surface Q1 of the fixation plate 38 by using an adhesive, for example.

(5) A method by which the liquid ejecting portion 32 ejects ink is not limited to the above described method (a piezoelectric method) which uses the piezoelectric element. For example, the invention also can be applied to a type of a liquid ejecting head (a thermal-type liquid ejecting head) using a heating element that generates air bubbles in a pressure chamber by rising the temperature to change the pressure in the pressure chamber. In addition, in the above-described embodiments, the line head in which the plurality of liquid ejecting heads 30 are arranged over the entire width of the medium 12 has been described. However, the invention also can be applied to a serial head in which a carriage with the liquid ejecting head 30 mounted thereon repetitively reciprocates in the X direction.

(6) The printing apparatus 10 in the above-described embodiments can be used as various apparatuses such as a facsimile apparatus and a copying machine in addition to the apparatus dedicated for printing. The purpose of use of the liquid ejecting apparatus of the invention is not limited to printing. For example, a liquid ejecting apparatus that ejects a solution of a coloring material is used as a manufacturing apparatus for forming a color filter of a liquid crystal display device. In addition, the liquid ejecting apparatus for ejecting a solution of a conductive material is used as a manufacturing apparatus for forming a wire and an electrode of a wiring substrate.

### REFERENCE SIGNS LIST

10 printing apparatus (liquid ejecting apparatus)

12 medium

14 liquid container

22 control device

24 transportation mechanism

242 first roller

244 second roller

26 liquid ejecting unit

28 sealing mechanism

282 sealing body

30 liquid ejecting head

32 liquid ejecting portion

34 supporter

36 flow path structure

38 fixation plate

382 supporting portion

384 peripheral edge portion

41 flow path substrate

42 pressure chamber substrate

43 vibrating plate

44 housing

45 sealing plate

46, 72 nozzle plate

47 compliance portion

472 elastic film

474 supporting plate

52 opening

54 filler

56 through hole

60 protrusion

62 end surface

64 side surface

68 bonded portion

Q1 first surface

Q2 second surface

N nozzle

SR reserving chamber

SC pressure chamber

SD damper chamber

1. A liquid ejecting head comprising:
a liquid ejecting portion for ejecting liquid from a plurality of nozzles;
a fixation plate that includes a first surface to which the liquid ejecting portion is fixed and a second surface which is opposite of the first surface and that is provided with an opening formed thereon which exposes the plurality of nozzles; and
a protrusion that is installed on the fixation plate and protrudes from the second surface.

2. The liquid ejecting head according to claim 1,
wherein a plurality of the liquid ejecting portions which are fixed to the first surface are provided, and
wherein the fixation plate is provided with a plurality of the openings formed thereon which correspond to the plurality of liquid ejecting portions.

3. The liquid ejecting head according to claim 2,
wherein the protrusion is installed between the plurality of openings.

4. The liquid ejecting head according to claim 2,
wherein the protrusion is installed being elongated in a second direction which intersects a first direction in which the plurality of openings are arranged.

5. (canceled)

6. The liquid ejecting head according to claim 1,
wherein the height of a central portion of the protrusion is larger than the height of an end portion of the protrusion.

7. The liquid ejecting head according to claim 1,
wherein the height of the protrusion is constant over an area of 90% or more of the entire length of the protrusion.

8. (canceled)

9. (canceled)

10. (canceled)

11. (canceled)

12. (canceled)

13. The liquid ejecting head according to claim 1,
wherein the fixation plate includes a peripheral edge portion which is bent with respect to the first surface, and
wherein the protrusion is not formed in a region between the peripheral edge portion and the opening.

14. The liquid ejecting head according to claim 1,
wherein a member of the liquid ejecting portion which is boded to the fixation plate does not overlap the protrusion in plan view.

15. The liquid ejecting head according to claim 1,
wherein a hydrophilic filler is formed in the opening of the fixation plate, and
wherein a surface of the protrusion is subjected to water-repellent treatment.

16. The liquid ejecting head according to claim 1,
wherein an angle between an end surface in a longitudinal direction of the protrusion and the second surface is smaller than an angle between a side surface of the protrusion and the second surface.

17. The liquid ejecting head according to claim 1,
wherein the second surface of the fixation plate includes an annular sealed region which abuts onto a sealing body which air-tightly closes the plurality of nozzles, and
wherein the protrusion is formed in a region on the second surface other than the sealed region.

18. The liquid ejecting head according to claim 17,
wherein the protrusion is formed on the inside of an inner peripheral edge of the sealed region.

19. The liquid ejecting head according to claim 1,
wherein the second surface of the fixation plate includes an annular sealed region which abuts onto a sealing body which air-tightly closes the plurality of nozzles, and
wherein at least a portion of the protrusion overlaps the sealed region on the second surface.

20. A line head which is elongated in a first direction, comprising:
an ejecting surface on which a plurality of nozzles ejecting liquid are installed; and
a protrusion that is installed along a second direction intersecting the first direction and protrudes from the ejecting surface.

21. (canceled)

22. (canceled)

23. The line head according to claim 20,
wherein a plurality of the protrusions are installed in a region in which the plurality of nozzles are distributed.

24. The line head according to claim 23,
wherein the plurality of protrusions are installed on a single member.

25. (canceled)

26. The line head according to claim 20,
wherein the height of the protrusion with respect to the ejecting surface is larger than the plate thickness of a substrate including the ejecting surface.

27. The line head according to claim 20, further comprising:
a reserving chamber that reserves liquid to be ejected from the plurality of nozzles,
wherein the protrusion is installed on a position which overlaps the resolving chamber in plan view.

28. The line head according to claim 20, further comprising:
a reserving chamber that reserves liquid to be ejected from the plurality of nozzles; and
a damper chamber for vibrating an elastic film that evens out a fluctuation in pressure in the resolving chamber,
wherein the protrusion is installed on a position which does not overlap the damper chamber in plan view.

29. (canceled)

30. (canceled)

31. The line head according to claim 20,
wherein an angle between an end surface in a longitudinal direction of the protrusion and the ejecting surface is smaller than an angle between a side surface of the protrusion and the ejecting surface.

32. (canceled)
